(19) United States
(12) Patent Application Publication
(10) Pub. No.: US 2002/0179704 A1
(43) Pub. Date: Dec. 5, 2002

(54) Enhanced digital wallet

(75) Inventor: Tom R. Deaton, Lawrenceville, GA (US)

Correspondence Address: Paul W. Martin, NCR Corporation, Law Department, ECD-2, 101 W. Schantz Avenue, Dayton, OH, 45479-0001, US

(73) Assignee: NCR Corporation

(21) Appl. No.: 09/874,745

(22) Filed: Jun. 5, 2001

(51) Int. Cl. G06K 15/00

(52) U.S. Cl. 235/383

(57) ABSTRACT

A digital wallet is operative to receive, maintain, and allow the retrieval of various forms of enhancements thereto, such as an electronic coupon, an electronic gift certificate, an electronic discount, and the like. The digital wallet is also operative to function as a primary or main digital wallet and thus accept and utilize a plurality of subordinate digital wallets, each one of which is separately operable within the framework of the digital wallet. In addition, each one of the subordinate digital wallets has different features and/or functionality. The primary digital wallet may also receive, maintain, and allow access to a shopping list of items that are automatically deleted or marked for deletion when an item corresponding to a shopping list item of the shopping list in the digital wallet is purchased on-line utilizing the primary digital wallet or at a physical store via a retail terminal, kiosk, or the like utilizing the primary digital wallet.

### FIELD OF THE INVENTION

The present invention relates generally to digital wallets and, more particularly, to applications and/or enhancements to digital wallets.

### DESCRIPTION OF THE PRIOR ART

In today's electronic commerce (e-commerce) environment, various ways have been proposed to provide security in financial transactions made over the Internet, especially with respect to consumer purchasing of goods and/or services from on-line retailers/stores (e-retailer). In addition to providing security measures for financial transactions, various schemes have been proposed and implemented that make it easier for a consumer to provide personal and account information to an e-retailer. One particular scheme is known as a digital wallet.

A digital wallet is a software component, typically consisting of various sub-component software components, modules, or the like, that allows a consumer to make an electronic payment with a financial instrument (such as a credit card or digital money) typically during an e-commerce transaction, and hides the low-level detail of executing the payment protocol that is used to make the payment. The digital wallet may also have other functionality that allows the consumer to provide shipping information, personal information, and other information to the e-retailer where necessary for the consummation of the transaction. The software component is preferably encryption software. The digital wallet essentially functions like a physical wallet during e-commerce transactions. The digital wallet can thus hold a consumer's payment information, a digital certificated to identify the consumer, shipping/address information, and the like to speed transaction processing. The consumer benefits because his/her information is encrypted against piracy and because the digital wallet may automatically input shipping information at the e-retailer's site, as well as give the consumer the choice of which financial instrument to use. This scheme provides a benefit to both the consumer and the e-retailer in many respects such as fraud protection and overall ease of the transaction.

Most digital wallets reside on the consumer's personal computer (PC) or other web-enabled device. Current browsers for PCs and other web-enabled devices now support digital wallets. However, this is not necessary. Thus, digital wallets may reside on a remote (i.e. non-consumer owned/operated) server such as a financial institution server, a digital wallet company server, and/or the like.

It has been shown above that digital wallets offer various advantages and/or benefits over other forms of performing financial transactions over the Internet. However, there are many shortcomings in the functionality and/or use of digital wallets.

It is thus an object of the present invention to provide additional functionality to a digital wallet.

### SUMMARY OF THE INVENTION

The present invention is a digital wallet that is operative to receive, maintain, and/or allow the retrieval of or access to various forms of enhancements and/or functionality.

In one form, a digital wallet is operative to receive, maintain, and/or allow access to a shopping list of items or a pointer to a shopping list of items. The shopping list contains a list of items for purchase by the consumer. When an item corresponding to an item on the shopping list is purchased utilizing the digital wallet, the shopping list item is indicated as having been purchased. Purchase may be made via an on-line e-retailer or via a retail terminal, kiosk, or the like.

In another form, a digital wallet is operative to receive, maintain, and/or allow access to a digital receipt or a pointer to a digital receipt as a result of a purchase transaction in which the digital wallet was utilized.

In yet another form, a digital wallet is operative to receive, maintain, and/or allow access to other digital wallets or pointers to other digital wallets. In particular, the digital wallet is operative to function as a primary or main digital wallet and thus accept and utilize a plurality of subordinate digital wallets, each one of which is separately operable within the framework of the digital wallet. Each one of the subordinate digital wallets includes different features and/or functionality.

In still another form, a digital wallet is operative to accept, maintain, and/or allow the retrieval of gift certificate data. The gift certificate data may be an electronic gift certificate or a pointer to an electronic gift certificate.

In a further form, a digital wallet is operative to accept, maintain, and/or allow the retrieval of coupon, discount, and/or special offer data. The coupon, discount, and/or special offer data may be an electronic coupon, discount, and/or special offer from a product manufacturer, retailer, and/or service provider, or a pointer thereto.

### BRIEF DESCRIPTION OF THE DRAWINGS

The above-mentioned and other features and advantages of this invention, and the manner of attaining them, will become more apparent and the invention will be better understood by reference to the following descriptions of embodiments of the invention taken in conjunction with the accompanying drawings, wherein:

FIG. 1 is a block diagrammatic view of an implementation of a digital wallet;

FIG. 2 is a diagram of an exemplary system that is operative to implement the various aspects of the present invention in accordance with the principles presented herein;

FIG. 3 is a diagrammatic view of a digital wallet in accordance with an aspect of the present invention;

FIG. 4 is a flow diagram of a manner of operation of an aspect of the present invention in accordance with the principles presented herein;

FIG. 5 is a flow diagram of a manner of operation of an aspect of the present invention in accordance with the principles presented herein;

FIG. 6 is a diagrammatic view of a digital wallet in accordance with an aspect of the present invention;

FIG. 7 is a flow diagram of a manner of operation of an aspect of the present invention in accordance with the principles presented herein;

FIG. 8 is a diagrammatic view of a digital wallet in accordance with an aspect of the present invention;

FIG. 9 is a diagrammatic view of a digital wallet in accordance with an aspect of the present invention; and

FIG. 10 is a flow diagram of a manner of operation of an aspect of the present invention in accordance with the principles presented herein.

Corresponding reference characters indicate corresponding parts throughout the several views.

### DETAILED DESCRIPTION

While the invention is susceptible to various modifications and alternative forms, the specific embodiment(s) shown and/or described herein is by way of example. It should thus be appreciated that there is no intent to limit the invention to the particular form disclosed, as the intention is to cover all modifications, equivalents, and alternatives falling within the spirit and scope of the invention as defined by the appended claims.

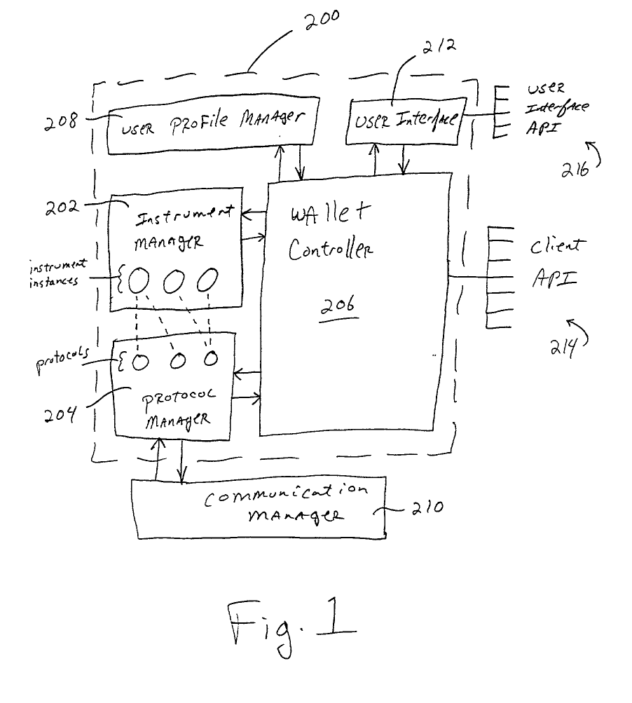

A structure of a digital wallet is depicted in FIG. 1 and reference is now made thereto. More particularly, FIG. 1 depicts a simplified, exemplary block diagram of a digital wallet, generally designated 200, of the type that forms a backbone for the various aspects (i.e. enhancements/applications) according to the principles of the present invention. As indicated above, the digital wallet 200 is a software or program instruction implementation of various concepts and/or functionality. The digital wallet 200 includes an instrument manager 202, a protocol manager 204, a wallet controller 206, a user profile manager 208, and a user interface 212. The digital wallet 200, via the protocol manager 204, interfaces with other software/program instructions via a communication manager 210. The user interface 212 may export parts of its interface as a user interface API (Application Program Interface) 216. The wallet controller 206 may be accessed/controlled by a client API, 214.

Particularly, the instrument manager 202 manages all of the instrument instances (represented by circles, as labeled in FIG. 1) contained in the digital wallet 200, and, for example, may be queried to determine which instrument classes and instances are available to execute a given payment or other operation 2. The protocol manager 204 manages all of the protocols that the digital wallet 200 may use to accomplish various operations, and invokes protocols (represented by circles, as labeled in FIG. 1) to carry out the interaction between the digital wallet 200 and vendors and banks. The protocol manager 204 relies on the communication manager 210 to process low-level communications requests with other computers representing the banks and vendors.

The wallet controller 206 presents a consolidated interface for the digital wallet 200 to the client. The wallet controller 206 hides the complexity of the other components of the digital wallet 200, and provides a high-level interface to the client. A non-human client, or software agent, can make method calls on the wallet controller's interface through the client API 214. A human client may use a Graphical User Interface (GUI) that may make method calls on the wallet controller 206. The wallet controller 206 coordinates the series of interactions between the user profile manager 208, the instrument manager 202, and the protocol manager 204, as necessary to carry out high-level requests received from the client, such as “purchase a product.”

The user profile manager 208 manages information about a client, clients and/or groups of clients of the digital wallet 200 including their user names, passwords, ship-to and bill-to addresses, and potentially other user profile information. In addition, the user profile manager 208 keeps access control information about what financial instruments each user has the authority to access.

The communication manager 210 provides the digital wallet 200 with an interface to send and receive string messages between digital wallets residing at different locations and peer commerce components by setting up a “connection” with a remote communication manager (i.e. of another, remote digital wallet). The protocol manager 204 builds on top of the “connection” abstraction to support the concept of a session. A “connection” is typically asynchronous, while communications between peer commerce components in a session occur in message/response pairs where one peer sends a message, the other peer receives the message and executes some action, and then returns a response. Depending upon the implementation of the communication manager 210, the messages may be sent over different types of networks using different communication protocols.

For example, one implementation of a communication manager 210 may send and receive messages over the Internet using HTTP requests and responses over a TCP/IP Ethernet network. In this case, a session may be made up of a sequence of several HTTP GET messages and their corresponding responses. In another example, a second implementation of a communication manager 210 may send and receive messages over an RS232 serial interface using TCP/IP.

Note that the protocol manager 204 is responsible for making calls to a cryptographic engine to encrypt any data that is passed to the communication manager 210, such that the data can be securely transmitted over the Internet. The communication manager 210 is preferably not responsible for encryption of sensitive data from the digital wallet 200 because it is formally outside the digital wallet architecture, and can be replaced by another communication manager to run the digital wallet on another device.

The client API 214 is an interface provided by the wallet controller 206 that may be used by an autonomous software agent acting on behalf of a consumer. The user interface 212 provides a graphical interface to the services offered by the wallet controller's interface. The user interface 212 is an optional component of the digital wallet 200 depending on the device in which the digital wallet programming is used. Some devices, such as most smart cards, do not have the ability to display a graphical user interface, and hence the wallet controller interface must be accessed through the client API 214. Note that the user interface 212 is preferably a core component within the digital wallet 200 because certain parts of the user interface 212 have access to sensitive consumer data. For example, an “edit box object” into which a user may enter a password to “unlock” the digital wallet should run within the wallet's protected address space. On the other hand, users may want to customize the wallet's interface by plugging in GUIs developed by various software vendors. To accomplish both of these conflicting goals, the user interface 212 exports parts of its interface as the user interface API 216 that may be overloaded by software vendors to render customized parts of the interface

It should be understood that the above description of a digital wallet is exemplary of an implementation or general structure of a digital wallet. Therefore, it should be appreciated that other implementations or structures of a digital wallet may be used.

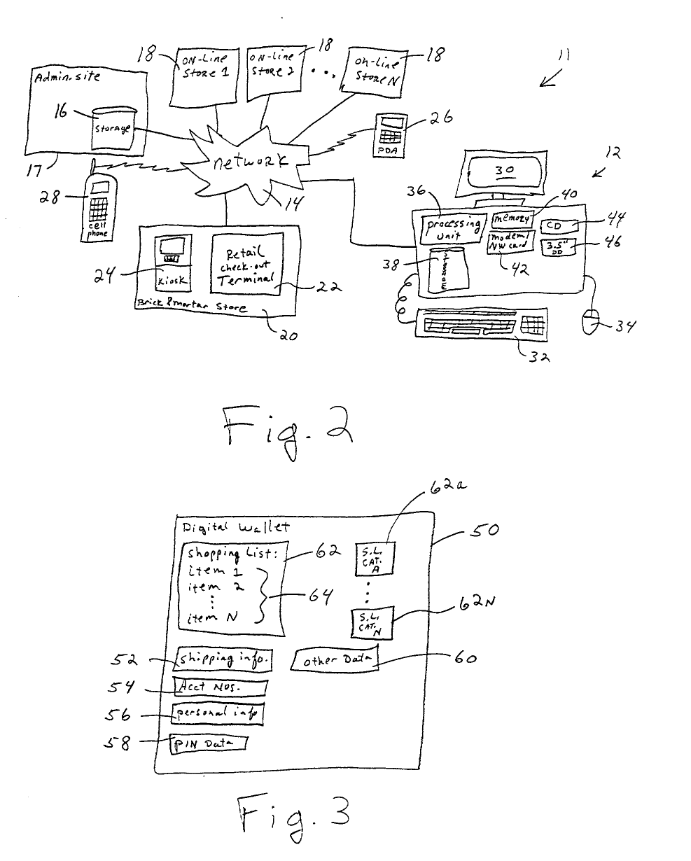

Referring now to FIG. 2, there is shown an exemplary system, generally designated 11, that is operative to implement the various aspects of the present invention. It should be appreciated, however, that not all of the components of the system 11 are necessary for the implementation of the various aspects of the present invention, nor are all of the components necessarily utilized for each aspect thereof.

The system 11 utilizes a network 14, preferably an electronic network such as the Internet, but which may be any type and/or form of a network. The system 11 includes a personal computer (PC) 12 that is in communication with the network 14 via a modem or network card 42 (communication device). A storage device 16, such as a data warehouse, is in communication with the network 14. The storage device 16 may be within an administration site 17. A plurality of on-line stores or retailers (i.e. e-retailers) generally designated 18 and represented by on-line store 1, on-line store 2, through on-line store N, are in communication with the network 14. Each e-retailer 18 is, at the least, a network site (e.g. web site) that offers products and/or services that may be purchased on-line through the PC 12 or other network or web-enabled device such as a Personal Digital Assistant (PDA) 26, a cell phone 28, and/or the like. The PDA 26 and the cell phone 28 provide wireless connection to the network 14. Additionally, a traditional (brick & mortar) store 20 may be in communication with the network 14 through a retail checkout terminal 22, a kiosk 24, other point-of-service (POS) terminal (not shown), or other device and/or system. While only one kiosk 24 and retail terminal 22 is shown, it should be appreciated that there may be a plurality of any one type of device/terminal and that the devices/terminals may be networked within the store 20, such as by a local area network (LAN) or the like. Although only one traditional store 20 is shown, there may be a plurality of traditional stores in communication with the network 14 in like manner to the e-retailers 18.

The PC 12 typically includes a display 30, user input devices such as a keyboard/keypad 32 and a mouse 34, program instructions/software/data storage 38 such as a hard drive, a processing unit 36, and memory 40 that is operative to at least temporarily store program instructions for execution by the processing unit 36. The PC 12 may have a CD or similar drive 44 and a disk drive 46. The PC 12 stores browser program instructions (browser) on the data storage 38 that along with the communication device 42 allows the connection to and communication with the network 14 in order to address the various devices also in communication with the network 14. Typically, the PC 12 is located in a home or office of the consumer/user, but could be a PC or similar network-enabled device located anywhere. In one form, the PC 12 also includes a digital wallet typically as part of the browser or as a plug-in to the browser. The digital wallet may alternatively be a stand-alone application that works without the browser. In another form, the digital wallet may be stored at or on another site such as a digital wallet site, credit card company site, or the like that administrators or administrates digital wallets for a plurality of consumers. The digital wallet may as well be part of a store's site. In any case, while the following is described in terms of the digital wallet being on the PC 12, it should be appreciated that the digital wallet may be on any site.

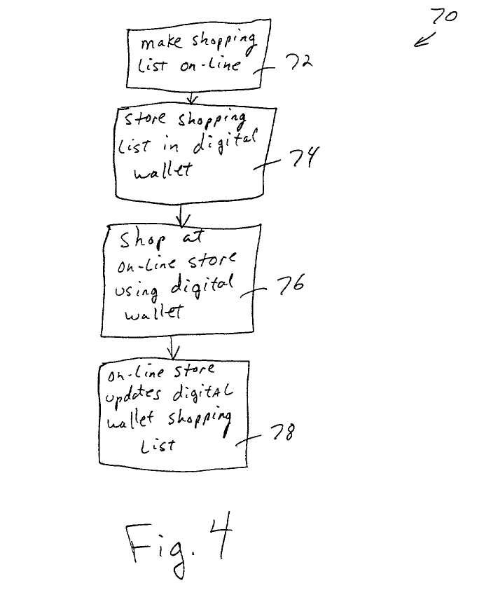

According to an aspect of the present invention, a site, such as the administration site 17, provides a shopping list program that is addressable by the PC 12. The shopping list program is executable at the PC 12 and allows the consumer to make an electronic shopping list that is stored in the consumer's digital wallet. Referring additionally to FIG. 3, a representation of a consumer's digital wallet, generally designated 50, is shown. The shopping list program makes a shopping list 62 that is attached to or made a part of the digital wallet 50. The shopping list 62 includes a plurality of items 64, represented by item 1, item 2 through items N. The shopping list items represent anything from grocery store items to consumer goods. The shopping list items may be categorized if desired and manipulated accordingly. Items may also be deleted to form a final shopping list. Once complete, the PC 12 (consumer) may return to the administration site 17 to update the shopping list 62. The shopping list 62 may be modified by additions and/or deletions as necessary. At any time, the shopping list 62 may be referenced. As well, shopping lists may be made for several individuals. In addition to the shopping list 62, the digital wallet 50 typically contains shipping information 52, account numbers 54 such as credit card numbers and the like, personal information 56, PIN data 58, and other data 60.

The shopping list program may generate a shopping list that is retained in storage at a particular site. In this instance, a pointer or address is provided to the digital wallet. The digital wallet is operative then to utilize the shopping list pointer when it is necessary to access the shopping list.

When the consumer performs on-line shopping at one of the e-retailers 18 and uses the digital wallet 50, any item that has been purchased at the e-retailer 18 that is also one of the items 64 of the shopping list 62 is automatically crossed off or deleted from the shopping list 64. The e-retailer 18 includes a storefront application that, along with a digital wallet portion that interacts/utilizes the digital wallet 50, will correlate any item purchased at their site with the items 64 of the shopping list 62. When a purchased item matches a shopping list item 64, the storefront application will remove or delete the matched item 64 from the shopping list, or indicate in some manner on or relative to the shopping list 62 that the item has been purchased.

Each e-retailer 18 that includes the shopping list storefront application operates in the same manner when the consumer purchases an item from that e-retailer. Thus, when a consumer purchases goods at different e-retailers, the shopping list 62 is updated by each e-retailer 18. At any time, the consumer may access the shopping list program and update the shopping list 64 as necessary, adding and/or deleting items.

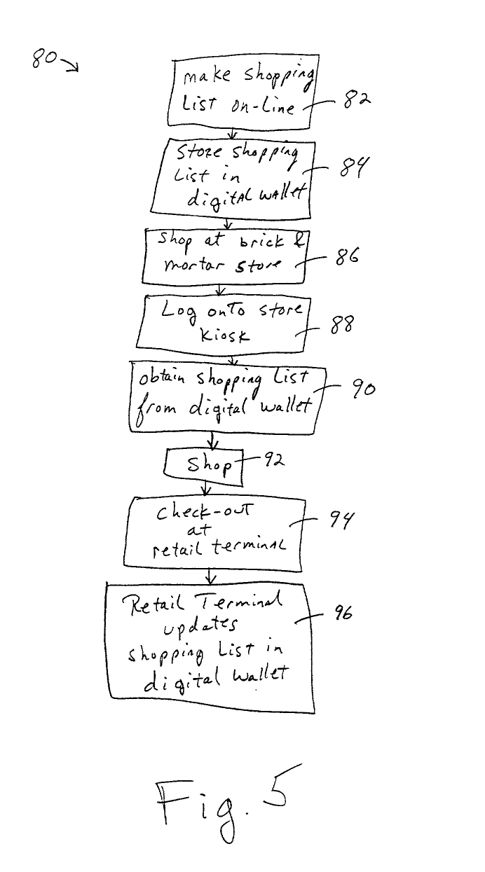

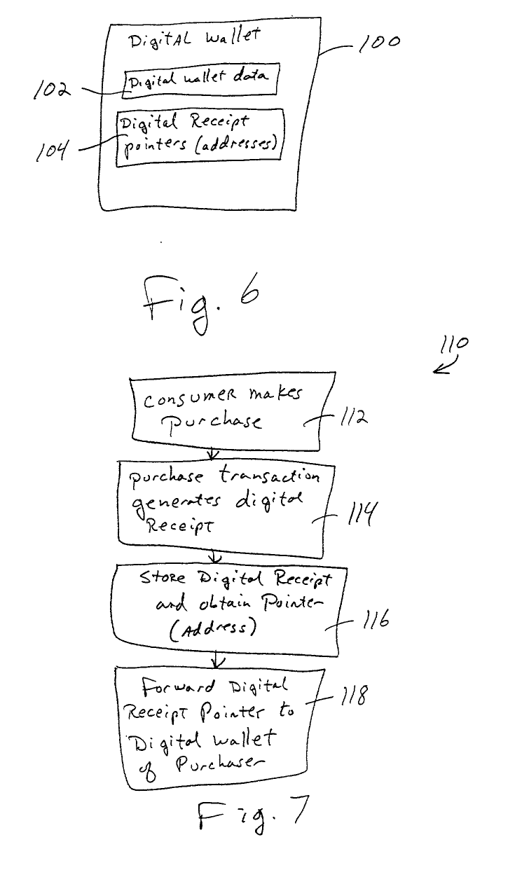

Referring to FIG. 4, there is depicted a flow diagram, generally designated 70, that illustrates an exemplary manner of operation of an aspect of the present invention. In particular, the flow diagram 70 illustrates an exemplary manner in which a shopping list may be utilized in conjunction with a digital wallet as discussed above. For purposes of the below discussion, it should be appreciated that a digital wallet is operable on the consumer's network-enabled device of choice. The network-enabled device may be the PDA 26, the PC 12, or the cell phone 28. Alternatively, the digital wallet is stored on the administration site 17 that is then accessed or referenced by the consumer's network-enabled device during the transaction.

Initially, the consumer connects to the network (“goes on-line”), accesses a shopping list program site, and prepares a shopping list, block 72. The compiled shopping list is then stored in the digital wallet, block 74. At any time, the consumer then shops at an on-line store using the digital wallet, block 76. The on-line store is able to utilize the digital wallet and the shopping list program. When a purchase is made by the consumer at the on-line store, the on-line store looks to see if any purchased item is an item of the shopping list, and updates the shopping list in the digital wallet accordingly, block 78. Updating the shopping list may include crossing out any items on the shopping list that have been purchased at the on-line store, deleting any items from the shopping list that have been purchased at the on-line store, or any other manner or indication that an item on the shopping list has been purchased. The consumer may shop at various different on-line stores without making another shopping list or may update the shopping list as necessary. Each on-line store that includes the shopping list program will update the shopping list as appropriate.

Referring back to FIG. 3, the shopping list program, is operable to produce categorized shopping lists that are stored with the digital wallet 50. Shopping lists 62a through 62N indicates the categorized shopping lists. Each shopping list provides a category for the items listed therein for, at least, easier compilation by the consumer. The categorized shopping lists 62ₐ through 62_{N} may be a subset of the main shopping list 62, or each may be a separate shopping list.

According to another aspect of the present invention, a consumer may not necessarily shop strictly at an e-retailer 18. The consumer may desire to shop at the brick and mortar store 20 (store 20). Under this scenario, the consumer has already compiled the shopping list 64 that is stored in the digital wallet 50. The store 20 includes the retail terminal 22 and, preferably as well, the kiosk 24 or like terminals/devices. The kiosk 24 is operable to obtain the shopping list 62 from the PC 12 via the network 14, and print the shopping list via an attached printer. The consumer may then manually check off the items from the shopping list as they are obtained.

The retail terminal 22 (point-of-service or POS unit 22) provides a checkout for purchasing of or paying for the obtained items. Each item includes a bar code or other indicia that is machine-readable. The retail terminal 22 is operable via a typical scanner to read the machine-readable indicia in order to determine the type of item being purchased in addition to other typical information encoded thereon. The retail terminal 22 is also operable to receive PIN data regarding the digital wallet or a digital wallet identification number in order to access the digital wallet 50. Once the digital wallet 50 is accessed by the retail terminal 20, the shopping list 62 is updated according to the items purchased and the items 64 on the shopping list 62. Additionally, the retail terminal 20 may utilize the typical payment features of the digital wallet 50. Thus, the retail terminal 20 includes a POS application that provides accessing a digital wallet and updating a shopping list contained therein.

Referring to FIG. 5, there is depicted a flow diagram, generally designated 80, that illustrates an exemplary manner of operation of an aspect of the present invention. In particular, the flow diagram 80 illustrates an exemplary manner in which a shopping list may be utilized in conjunction with a digital wallet as discussed above. For purposes of the below discussion, it should be appreciated that a digital wallet is operable on the consumer's network-enabled device of choice. The network-enabled device may be the PDA 26, the PC 12, or the cell phone 28. Alternatively, the digital wallet is stored on the administration site 17 that is then accessed or referenced by the store 20 during the transaction.

Initially, the consumer connects to the network (“goes on-line”), accesses a shopping list program site, and prepares a shopping list, block 82. The compiled shopping list is then stored in the digital wallet, block 84. The consumer then shops at a brick and mortar store, block 86. At any time the consumer logs onto the kiosk, block 88. The kiosk accesses the digital wallet to retrieve the shopping list, block 90. Thereafter, the consumer shops, block 92.

When the consumer is finished shopping and is ready to pay for the selected goods, the consumer checks out at the retail terminal, block 94. During checkout, the retail terminal obtains information regarding the purchased items and the digital wallet of the consumer in order to access the digital wallet. The retail terminal then updates the shopping list in the digital wallet, block 96.

In accordance with another aspect of the present invention, and with reference back to FIG. 2, the store 20 is operative to generate a digital receipt for a purchase transaction. A purchase transaction may include purchase of an item or items and/or return of an item or items. The digital receipt is an electronic or other non-paper, machine generated representation of a paper receipt for the purchase transaction that may include other various types of information in addition to information provided on a paper receipt. In particular, the retail terminal 22, kiosk 24, or any other terminal or device that performs, or assists in the performance of the purchase transaction consummates the transaction, generates a digital receipt for the purchase transaction. In the present discussion, it will be assumed that the retail terminal 22 is performing the purchase transaction. The digital receipt generated or produced by the retail terminal 22 is then forwarded or transmitted to a storage device or location for storage. The storage device/location may be local, such as at the store 20, or may preferably be remote, such as the storage device 16. In the present discussion, it will be assumed that the digital receipt is stored in the storage device 16 and, as well, that the storage site is part of the administration site 17. The digital receipt is stored in the storage device 16 at a particular location or address that allows the digital receipt to be retrievable at a later time. During or after the purchase transaction, the retail terminal 22 ascertains the location or address of, or a pointer to the location/address of the stored digital receipt. The retail terminal 22 is operative to forward the address of the storage location of the digital receipt, or the pointer thereof, to the digital wallet of the consumer.

Preferably, the address or pointer is forwarded or transmitted to the digital wallet via the network 14. However, other manners of forwarding the address or pointer to the digital receipt is contemplated, such as via any type of writable card (e.g. a smart card or a magnetic strip card). The digital wallet 100 (see FIG. 6) is operative to receive and store the address or pointer. In the case of the network 14 being the Internet, the address is preferably a URL (Uniform Resource Locator) or a pointer to the URL. The address or pointer allows the owner of the digital wallet 100 to access the particular digital receipt. The administrative site 17 also includes applications or programs that are functional over the network 14 that allow an authorized user to review their digital receipt(s), generate a report or reports regarding the digital receipt(s), and perform other functions with regard to the stored digital receipt(s), such as provide verification of the data contained therein.

In FIG. 6, a digital wallet, generally designated 100, is representationally depicted. The structure of the digital wallet 100 may be the same or similar to that described above, and thus includes typical digital wallet data 102. In accordance with the above, the digital wallet 100 is adapted to receive pointers or addresses 104 that correspond to the storage location of a particular digital wallet or define the digital wallet by the storage device/location. In addition, the address or pointer provides access to applications or programs that relate to the digital receipt. The digital wallet 100 is operative to receive and store a plurality of addresses/pointers each one of which corresponds to a particular digital receipt.

Referring to FIG. 7, a manner of operation of the above-described aspect of the present invention is depicted in a flow diagram or chart generally designated 110. It is assumed for the purposes of FIG. 7 that the purchase transaction occurs at a brick and mortar store 20, however, the purchase transaction may occur at another type of establishment or place of business such as an on-line store. Initially, the consumer makes a purchase (i.e. a purchase transaction), block 112. The purchase transaction generates a digital receipt, block 114. The generated digital receipt is stored in a storage device and a pointer or address for the particular digital receipt is obtained, block 116. The address or pointer is then forwarded to the digital wallet of the purchaser, block 118. The address or pointer allows the consumer to access the storage location of the digital receipt (the digital receipt) in order to view the digital receipt, print the digital receipt, generate and/or print a report or reports regarding the digital receipt, and perform various applications with respect to the digital receipt.

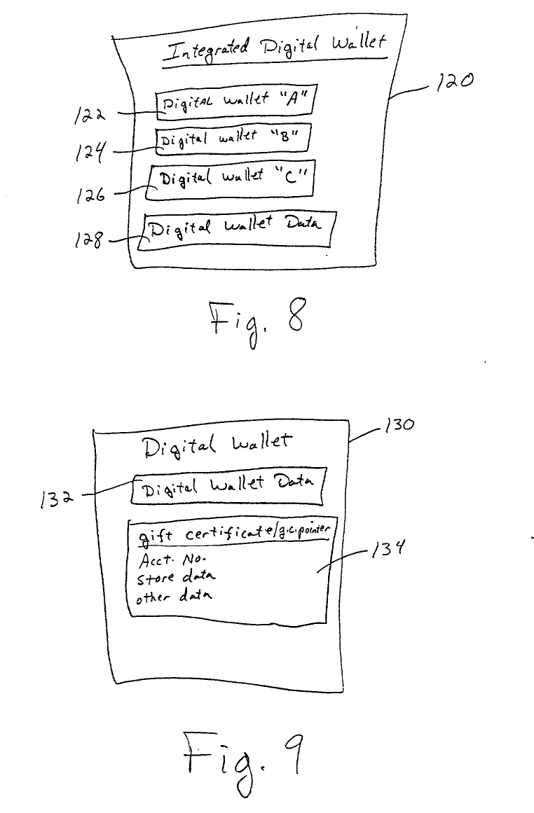

According to another aspect of the present invention and, referring to FIG. 8, a representational main digital wallet, generally designated 120, is adapted to store or link multiple subordinate digital wallets 122, 124, and 126. Each subordinate digital wallet 122, 124, and 126 is a self-contained digital wallet, typically from a particular vendor. Each subordinate digital wallet 122, 124, and 126 is formatted and/or includes data that is different in at least some respects than the other subordinate digital wallets. This allows a consumer to utilize a single, main digital wallet across multiple digital wallet suppliers, vendors, or the like.

In particular, the digital wallet 120 is an integrated digital wallet that includes digital wallet data 128. The structure of the digital wallet 100 may be the same or similar to that described above and thus includes typical digital wallet data 128. The digital wallet data 128 may include information pertinent to the configuration and/or structure of the main digital wallet 120 with regard to the subordinate digital wallets 122, 124, and 126. The digital wallet data 128 may include information regarding the subordinate digital wallets 122, 124, and 126 such as linking information.

The main digital wallet 120 provides an integrated approach to digital wallets from different vendors or providers, since each digital wallet may have different features. These features may or may not be compatible with each other. As an example, suppose the subordinate digital wallet 122 is from Vendor “A” (digital wallet “A”) and that the digital wallet “A” can be used for on-line shopping only on Vendor A's site. Suppose the subordinate digital wallet 124 is from Vendor “B” (digital wallet “B”) and that the digital wallet “B” can be used only for on-line shopping across multiple sites affiliated with Vender “B”. Suppose further the subordinate digital wallet 126 is from Vendor “C” (digital wallet “C”) and that the digital wallet “C” a digital wallet that can be used only at sites that utilize the same digital wallet software as the digital wallet “C”. By allowing the main or integrated digital wallet 120 to accept or store a plurality of subordinate digital wallets, a single digital wallet can be used across multiple vendors or online sites. It should be appreciated that while three subordinate digital wallets are depicted, the main digital wallet 120 may contain more or less subordinate digital wallets. As well, the term “subordinate” should not be construed to connote that the functionality, features or importance of the various digital wallets contained in the main or integrated digital wallet 120 is lessened.

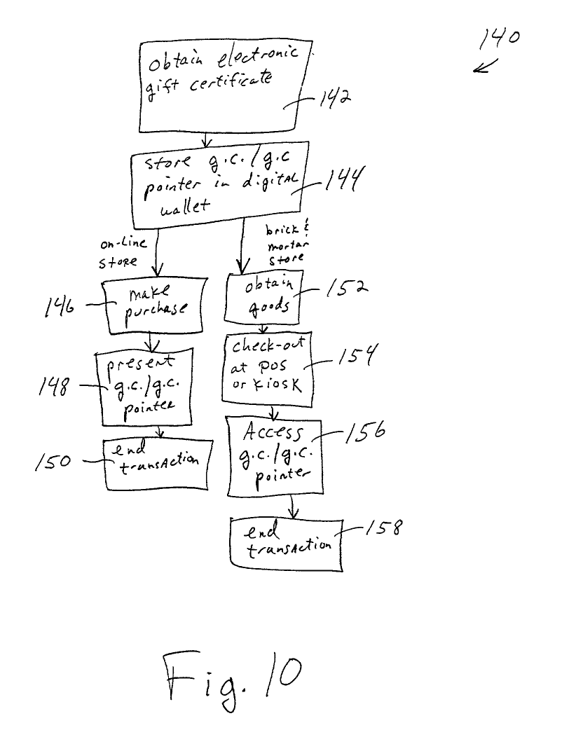

According to another aspect of the present invention and, referring to FIG. 9, a representational digital wallet, generally designated 130, is adapted to receive and/or store digital or electronic gift certificates. A digital gift certificate is an electronic version of paper gift certificates (or gift cards). The structure of the digital wallet 130 may be the same or similar to that described above and thus includes typical digital wallet data 132. In addition to digital wallet data 132, the digital wallet 130 contains a gift certificate or a gift certificate pointer 134 (collectively hereinafter, gift certificate). It should be appreciated that while only one gift certificate/gift certificate pointer 134 is depicted and described herein, the digital wallet 130 may contain a plurality of gift certificates/gift certificate pointers.

In particular, the digital wallet 130 contains the gift certificate 134 that includes various information such as an account or certificate number, issuing store data, and other data necessary to identify the type, use, amount, and various pertinent information. The digital wallet 130 is operative to allow reference to and use of the gift certificate 134 while shopping on-line at an e-retailer 18. The digital wallet 130 is also operative to allow the use of the gift certificate from a brick and mortar store 20 through the retail terminal 22 or the kiosk 24. In the case where the digital wallet 130 contains a pointer to an electronic gift certificate, the digital wallet 130 provides access to the electronic gift certificate via the pointer. In this case, the electronic gift certificate is stored at the particular e-retailer 18, at a corporate site of a particular e-retailer, a storage device 16 at an administrative site 17, or the like.

The electronic gift certificate is obtained by anyone either on-line via an e-retailer 18 or at a brick and mortar store 20 in a manner conventional with purchasing gift certificates. After purchase, the gift certificate or pointer is electronically forwarded to the appropriate digital wallet. The appropriate digital wallet is ascertained by e-mail address, account number, other identification, and/or any other means.

Referring to FIG. 10, a manner of operation of the above-described aspect of the present invention is depicted in a flow diagram or chart generally designated 140. Initially, the electronic gift certificate is obtained, block 142. The gift certificate or a pointer (address) to a gift certificate is then forwarded to and stored in the digital wallet, block 144. At this point, the consumer may shop either on-line or at a physical store.

Assuming, first, that the consumer is shopping on-line at an e-retailer, the consumer reviews the site to make a purchase and/or begins the purchase transaction by selecting the goods or services to be purchased and follows the on-line purchasing instructions, block 146. During the payment process for the merchandise or services being purchased, the consumer provides their digital wallet identification number or other identifier to the e-retailer in order to utilize or present their gift certificate, block 148. With the digital wallet identification number, the e-retailer accesses the consumer's digital wallet and obtains either the gift certificate (gift certificate data) for processing or the gift certificate pointer that provides the address for the gift certificate data. After the gift certificate/pointer has been presented to the e-retailer, the transaction ends, block 150.

Assuming, secondly, that the consumer is shopping at a physical store, the consumer obtains the merchandise to be purchased, block 152. The merchandise is transported to a checkout station, which is an assisted or non-NCR assisted retail terminal, kiosk or the like (collectively retail terminal), block 154. During the checkout process at the retail terminal, the consumer provides their digital wallet identification number or other identifier in order for the retail terminal to access their gift certificate or gift certificate pointer, block 156. The digital wallet identification number or other identifier may be presented to the retail terminal in a variety of manners, such as via a magnetic strip card, smart card, RFID card, manually, or by any other means. The retail terminal then accesses the digital wallet to obtain the gift certificate (data regarding the gift certificate) or the gift certificate pointer in order to obtain the gift certificate data from the particular storage location. After the retail terminal has obtained the data and applied the gift certificate to the purchase, the transaction ends, block 158.

According to another aspect of the present invention, a digital wallet may contain digital or electronic coupons in the same or similar manner as the digital wallet 130 receives and/or contains gift certificates and/or gift certificate pointers. A retailer, a manufacturer, or a third party coupon-issuing vendor issues a digital coupon. The digital coupon contains data regarding the coupon and would be either directly stored in the consumer's digital wallet or indirectly via a pointer stored in the consumer's digital wallet. The coupon pointer would provide an address where the digital coupon (data) would be kept. Redemption of the digital coupon would be in the same or similar manner as the redemption of a digital gift certificate.

According to yet another aspect of the present invention, a digital wallet may contain digital or electronic discounts and/or special offers in the same or similar manner as the digital wallet 130 receives and/or contains gift certificates and/or gift certificate pointers. A discount or special offer contains data regarding the discount or special offer and would be either directly stored in the consumer's digital wallet or indirectly via a pointer stored in the consumer's digital wallet. The discount/special offer pointer would provide an address where the digital discount/special offer (data) would be kept. Redemption of the digital discount/special offer would be in the same or similar manner as the redemption of a digital gift certificate.

It should be appreciated that the various aspects of the present invention have herein been described separately. The various aspects, however, may be combined in any manner.

While this invention has been described as having a preferred design and/or configuration, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the claims.

What is claimed is:

1. A method of consummating a purchase transaction comprising:
obtaining merchandise data for merchandise being purchased by a consumer;
calculating a price for the merchandise being purchased;
generating a digital receipt for the merchandise being purchased;
obtaining digital wallet data from the consumer; and
providing digital receipt data to the digital wallet of the consumer.

2. The method of claim 1, wherein providing digital receipt data to the digital wallet of the consumer comprises providing the digital receipt to the digital wallet of the consumer.

3. The method of claim 2, wherein providing digital receipt data to the digital wallet of the consumer comprises providing the digital receipt data to the digital wallet of the consumer via the Internet.

4. The method of claim 1, further comprising:
storing the digital receipt in an addressable storage device;
obtaining an address of the storage location of the digital receipt in the addressable storage device; and
wherein providing digital receipt data to the digital wallet of the consumer comprises providing a pointer to the address of the storage location of the digital receipt to the digital wallet of the consumer.

5. The method of claim 4, wherein providing a pointer to the address of the storage location of the digital receipt to the digital wallet of the consumer comprises providing a pointer to the address of the storage location of the digital receipt to the digital wallet of the consumer via the Internet.

6. A digital wallet comprising:
digital wallet program instructions; and
digital wallet data;
said digital wallet program instructions operative to allow receipt, storage, and retrieval of digital receipt data.

7. The digital wallet of claim 6, wherein said digital receipt data comprises a digital receipt.

8. The digital wallet of claim 6, wherein said digital receipt data comprises a pointer to an address of a storage location of a digital receipt.

9. An apparatus for consummating a purchase transaction comprising:
a processing unit;
a merchandise data receiver in communication with said processing unit and operative to obtain data from merchandise being purchased;
a data receiver in communication with said processing unit and operative to obtain data from a consumer; and
memory in communication with said processing unit and containing a plurality of program instructions, which, when executed by said processing unit, causes said processing unit to:
obtain merchandise data for merchandise being purchased via said merchandise data receiver;
calculate a price for the merchandise being purchased;
generate a digital receipt for the purchase transaction;
obtain consumer data via said consumer data receiver regarding a digital wallet of the consumer; and
provide digital receipt data to the digital wallet of the consumer.

10. The apparatus of claim 9, wherein the memory contains further program instructions, which, when executed by said processing unit, causes said processing unit to provide the digital receipt data as the digital receipt to the digital wallet of the consumer.

11. The apparatus of claim 10, wherein the memory contains further program instructions, which, when executed by said processing unit, causes said processing unit to provide the digital receipt to the digital wallet of the consumer via the Internet.

12. The apparatus of claim 9, wherein the memory contains further program instructions which, when executed by said processing unit, causes said processing unit to:
store the digital receipt in an addressable storage device;
obtain an address of the storage location of the digital receipt in the addressable storage device; and
provide the digital receipt data as a pointer to the address of the storage location of the digital receipt to the digital wallet of the consumer.

13. The apparatus of claim 12, wherein the memory contains further program instructions which, when executed by said processing unit, causes said processing unit to provide the pointer to the address of the storage location of the digital receipt to the digital wallet of the consumer via the Internet.

14. A digital wallet comprising:
digital wallet program instructions; and
digital wallet data;
said digital wallet program instructions supporting a plurality of subordinate digital wallets each having subordinate digital wallet program instructions and subordinate digital wallet data, wherein each subordinate digital wallet is separately operative.

15. The digital wallet of claim 14, wherein the digital wallet program instructions are operative to link the plurality of subordinate digital wallets to the digital wallet program instructions such that each subordinate digital wallet is separately operative under control of the digital wallet program instructions.

16. The digital wallet of claim 14, wherein each subordinate digital wallet comprises a digital wallet having different functionality.

17. A digital wallet comprising:
digital wallet program instructions; and
digital wallet data;
said digital wallet program instructions supporting receipt, storage, and retrieval of gift certificate data.

18. The digital wallet of claim 17, wherein said gift certificate data comprises an electronic gift certificate.

19. The digital wallet of claim 17, wherein said gift certificate data comprises a pointer to an electronic gift certificate.

20. A digital wallet comprising:
digital wallet program instructions; and
digital wallet data;
said digital wallet program instructions operative to maintain a shopping list comprising at least one shopping list item, wherein when the digital wallet is utilized to purchase merchandise corresponding to an item on said shopping list, said digital wallet program instructions provide an indication that the corresponding item has been purchased.

21. The digital wallet of claim 20, wherein the indication that a corresponding shopping list item has been purchased comprises deletion from said shopping list.

22. The digital wallet of claim 20, wherein the shopping list is updateable at any time.

23. The digital wallet of claim 22, wherein updateable comprises additions and deletions of shopping list items.
